(19) United States
(12) Patent Application Publication
(10) Pub. No.: US 2018/0069228 A1
(43) Pub. Date: Mar. 8, 2018

(54) Electrical Energy Store Having a Remote Controllable Locking Device

(71) Applicant: Bayerische Motoren Werke Aktiengesellschaft, Muenchen (DE)

(72) Inventor: Reiner PFEIFER, Muenchen (DE)

(21) Appl. No.: 15/810,255

(22) Filed: Nov. 13, 2017

Related U.S. Application Data
(63) Continuation of application No. PCT/EP2016/062435, filed on Jun. 2, 2016.

(30) Foreign Application Priority Data
Jul. 29, 2015 (DE) 10 2015 214 303.1

(51) Int. Cl. H01M 2/34; B60R 25/045

(52) U.S. Cl. CPC H01M 2/341; H02J 7/007; B60R 25/045

(57) ABSTRACT

An electrical energy store for providing electrical drive energy for a motor vehicle includes an integrated locking device, which is designed for remotely controllable locking and/or unlocking of at least one electrical external contact of the energy store.

### CROSS REFERENCE TO RELATED APPLICATIONS

This application is a continuation of PCT International Application No. PCT/EP2016/062435, filed Jun. 2, 2016, which claims priority under 35 U.S.C. § 119 from German Patent Application No. 10 2015 214 303.1, filed Jul. 29, 2015, the entire disclosures of which are herein expressly incorporated by reference.

### BACKGROUND AND SUMMARY OF THE INVENTION

The invention relates to an electrical energy store for providing electrical drive energy for a motor vehicle, and to an electrically driven motor vehicle as well as a method for remotely controllable locking or unlocking of the electrical energy store.

The effect of the increasing electrification of motor vehicles of all kinds, in particular passenger motor vehicles, but also including motorcycles and motor scooters, is that the installed energy stores, which have a high value as compared with the vehicle price, are becoming the targets of thieves.

Since the energy stores have, as a rule, a modular, exchangeable design, unauthorized pilfering cannot be entirely ruled out, in spite of various mechanical safeguards. Electrically driven motorcycles and scooters, whose energy stores are easily accessible due to the open construction of the vehicles when parked, are particularly affected by this. Theft from passenger motor vehicles cannot, however, be excluded, particularly in workshops. Stolen energy stores are usually used as replacement parts for other vehicles or for other purposes. The misuse of electrical energy stores for arson purposes is also known.

The object of the invention is, therefore, to protect the electrical energy store from theft, or at least to reduce the incentive for the thieves.

This and other objects are achieved by an electrical energy store, an electrically driven motor vehicle, as well as a method for remotely controllable locking or unlocking of an electrical energy store, in accordance with embodiments of the invention.

An electrical energy store for providing electrical drive energy for a motor vehicle is accordingly provided, wherein the electrical energy store comprises an integrated locking device, which is designed for remotely controllable locking and/or unlocking of at least one external electrical contact of the energy store.

An electrical energy store, as used herein, refers in particular to rechargeable battery modules or accumulators, which are usually composed of a number of individual storage cells. Lithium ion batteries are at present preferably being used for electrically driven motor vehicles. The invention is not, however, restricted to particular battery materials, but can also be employed with electrical energy stores composed of different materials.

The electrical energy store is thus also equipped according to the invention with the locking device which can be operated from a distance and which can lock or again unlock, or enable, external electrical contacts. As a result of the locking of the contacts, one or more external electrical contacts of the energy store are blocked in such a way that, for example, no more electrical power for the electrical drive of the vehicle can be supplied to the energy store (charging process), or can be drawn from it (charge removal). External electrical contacts refer in particular to electrical interfaces for the output of power and/or to signal and/or communication interfaces for the use of the energy store. In this way the power output and/or an operation of electronics of the energy store can thus be locked, and the operation of the energy store thus prevented.

A further use of the locked energy store in a different vehicle or for other purposes is thus effectively prevented. The incentive for theft is correspondingly significantly reduced. As long as the energy store remains installed in the original vehicle and is locked, the arrangement described furthermore offers the function of an immobilizer, since the energy store is deactivated in such a way that any use of the vehicle as a whole is prevented at the same time.

The locking device can, as will be described below, be designed in such a way that only the authorized owner, a dealer and/or a workshop can release the lock. A status indicator, for example an LED, which indicates the current status of the locking device, can be arranged visibly on the housing of the energy store as a visible deterrent.

The locking device can, for example, be designed for the physical and/or electrical locking and/or unlocking of the at least one external electrical contact of the energy store. In this way it should be ensured that the respective locked contact cannot carry any current, and an unlawful unlocking is prevented. The locking device is arranged for this purpose inside the energy store, and is preferably so designed that a locking or unlocking of the external contacts is effected inside the energy store. As a result of this integration of the locking device into the energy store, an attempt at manipulation would require an opening of, and an associated damage to, the energy store.

According to an advantageous embodiment, the locking device is designed for the exchange of communication with a communication unit in order to perform the locking in reaction to a lock signal transmitted from the communication unit to the locking device and/or, to carry out the unlocking in reaction to an unlock signal transmitted from the communication unit to the locking device.

In both cases the locking device is driven by a corresponding signal of the communication unit. The communication link between the locking device and the communication unit can therefore be designed uni-directionally exclusively for the transmission of signals in the direction of the locking device or, alternatively, bi-directionally for mutual information exchange between the locking device and the communication unit. In the latter case, information regarding a current status or the successful conclusion of a lock or unlock process can, for example, be transmitted to the communication unit in order, for example, to inform a user.

The communication unit can, for example, be integrated into the electrical energy store or can be attached to the motor vehicle outside the energy store. This means that the energy store can be designed as a complete module, in that it comprises both the locking device and the communication unit. It is advantageous that the energy store is designed compactly as a closed, complete module, and a communication between the user and the communication unit that is integrated into the energy store can take place autonomously without the vehicle and its electronics being required for this to occur. Locking is also then possible when the energy store is not (or is no longer) installed in the vehicle.

The communication unit can alternatively be attached to the vehicle. This means that either a separate communication unit is provided for communication with the locking device of the energy store in the vehicle, and for this purpose is connected through communication technology. It is, however, equally possible for a communication unit provided in the vehicle for other purposes to be designed for communication with the locking device and to be connected in terms of communication technology. An arrangement of this sort minimizes the complexity of the energy store and keeps its physical size compact.

In either case the communication unit can be designed for direct communication with an external signal transmitter, in particular a remote controller, a portable hand-held device, a mobile telephone, a smartphone, a portable computer or a tablet, etc., in order to trigger the locking signal in reaction to a lock command from the signal transmitter, and/or to trigger the unlocking signal in reaction to an unlock command from the signal transmitter.

The communication unit can, for example, be designed for wireless communication with the external signal transmitter, in particular by means of infrared, NFC (“Near Field Communication”), WLAN, Bluetooth, or by means of mobile radio communication, etc.

Depending on the design of the type of wireless communication used, a communication link can be established directly and immediately between the communication unit and the external signal transmitter, or, however, indirectly or non-immediately through an infrastructure that is connected in between.

In the first case the user is enabled to activate the locking device to lock or unlock the energy store through the external signal transmitter, provided he is in the vicinity of the vehicle, so that the external signal transmitter can communicate directly with the communication unit, i.e. without the intermediate connection of an additional infrastructure. A large number of technical standards for wireless communication are known for such a local, wireless communication over short and medium distances.

Alternatively or in addition, the communication can take place indirectly by way of mobile radio communication, wherein the external signal transmitter is usually connected with a mobile radio infrastructure, and through that infrastructure is in communicative connection with the communication unit which, for its part, is also connected to the mobile radio infrastructure. Mobile radio infrastructure refers in particular to the mobile radio network provided by a mobile telephony provider, with which both the external signal transmitter and also the communication unit can be connected for one-way or reciprocal data transmission. In this way it is possible to perform operation of the locking device not only over a short or medium distance, but also remotely.

Depending on the design of the external signal transmitter, it is possible for, example, for an appropriate software, in particular an appropriate program also referred to as an application or app, to be provided and to be executable on it, in order to activate the locking device.

An electrically driven motor vehicle with an electrical energy store is further disclosed, wherein the electrical energy store is designed according to the description given above. Passenger motor vehicles, motorcycles, scooters or other motorcycle-like vehicles may, in particular, be considered as motor vehicles.

As described, the locking device can be connected to a communication unit attached to the motor vehicle for communication exchange. The communication unit in this form of embodiment is accordingly installed in the vehicle outside the energy store.

A method for remotely controllable locking or unlocking of an electrical energy store is further provided. The energy store is designed according to the description given above. The method includes the following acts:

transmission of a command for locking or unlocking to a communication unit;

reception of the command by the communication unit and processing the command to form a locking signal or an unlocking signal;

transmission of the locking signal or of the unlocking signal to the locking device; and

activation of the locking device to lock or unlock the energy store in reaction to the locking signal or the unlocking signal.

Preferably, the act of activating the locking device to lock includes a physical and/or electrical disconnection of a contact of the at least one external electrical contact of the energy store. The disconnection of the contact includes in particular the disconnection of a contact with vehicle components, in particular components of the electrical drive or control devices, that are arranged outside the energy store. The disconnection itself preferably takes place inside the energy store.

Preferably again, the step of activating the locking device to unlock includes a physical and/or electrical establishment of a contact of the at least one external electrical contact of the energy store. The establishment of the contact includes in particular the establishment of a contact with vehicle components, in particular components of the electrical drive or control devices, that are arranged outside the energy store. The establishment of a contact itself preferably takes place inside the energy store.

The command transmitted to the communication unit can, moreover, be an encrypted code for locking and/or unlocking.

In this case, the action of processing the command can include a verification and/or decoding of the code.

The action of transmitting a command can, for example, be made by a user by way of an external signal transmitter, in particular by means of a remote controller, a portable hand-held device, a mobile telephone, a smartphone, a portable computer or tablet.

According to a further form of embodiment, the method can moreover include a transmission of a confirmation signal of the communication unit regarding the successful execution of the unlocking or locking of the energy store to the external signal transmitter. A successful actuation of the locking device in this way is returned to the external signal transmitter and thus to the user.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of a first embodiment of an electrical energy store according to the invention.

FIG. 2 is a schematic diagram of a second embodiment of an electrical energy store according to the invention.

FIG. 3 is a flow diagram of a method according to an embodiment of the invention.

### DETAILED DESCRIPTION OF THE DRAWINGS

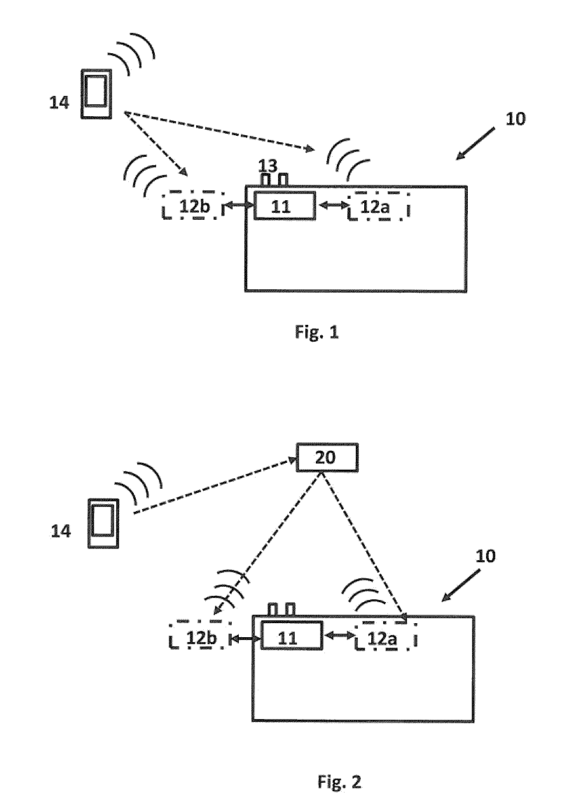

FIG. 1 shows a schematic illustration of an electrical energy store 10 for the provision of electrical drive energy for a motor vehicle (not illustrated). The electrical energy store 10 includes an integrated locking device 11, which is designed for remotely controllable locking and/or unlocking of at least one external contact 13 of the energy store 10. The locking device 11 can, in particular, be configured for the physical and/or electrical locking and/or unlocking of the at least one external contact 13 of the energy store 10 in order to prevent unauthorized use.

The locking device 11 can, moreover, be configured for a communication exchange with a communication unit 12a, 12b, in order to perform the locking in reaction to a lock signal transmitted from the communication unit 12a, 12b to the locking device 11 and/or to carry out the unlocking in reaction to an unlock signal transmitted from the communication unit 12a, 12b to the locking device 11.

Two alternative variants of the arrangement of a communication unit 12a, 12b are illustrated, according to which the communication unit 12a, 12b is either integrated into the electrical energy store 10 or can be attached to the vehicle outside the energy store 10. The dashed illustration of the two communication units 12a, 12b is to be understood to mean that these are to be considered as alternatives, and are not to be provided at the same time. It is true that a simultaneous arrangement of two communication units is possible, but it is not intended.

The communication unit 12a, 12b in the embodiment illustrated in FIG. 1 is designed for direct communication with an external signal transmitter 14, in particular a remote controller, a portable hand-held device, a mobile telephone, a smartphone, a portable computer or a tablet, etc., in order to trigger the locking signal in reaction to a lock command from the signal transmitter 14, and/or to trigger the unlocking signal in reaction to an unlock command from the signal transmitter 14.

For this reason, the communication unit 12a, 12b is configured for wireless communication with the external signal transmitter 14, in particular by way of direct wireless communication, for example via infrared, NFC, WLAN and/or Bluetooth.

FIG. 2 illustrates a largely identical second embodiment in which the elements which are identical or similar to, or which correspond to, the first embodiment according to FIG. 1 are identified by the same reference signs. The description given for FIG. 1 is therefore referred to for their explanation. The difference of the second embodiment according to FIG. 2 is that the communication unit 12a, 12b is designed for indirect wireless communication with the external signal transmitter 14, in particular by way of mobile radio communication. This means that in this case a communication between the communication unit 12a, 12b and the external signal transmitter 14 is not handled directly, but via a mobile radio infrastructure 20, for example a mobile telephony supplier.

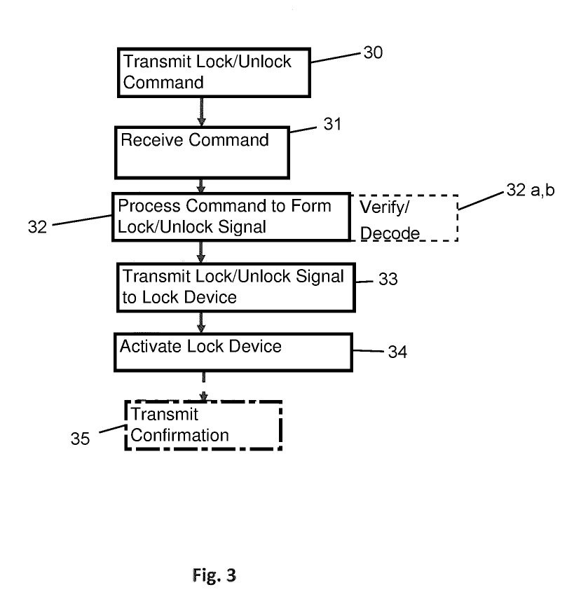

FIG. 3 shows a flow diagram of a method for remotely controllable locking or unlocking of an electrical energy store, wherein the energy store 10 is configured as described above, in particular with respect to the description for FIG. 1 or 2 given above. The method is carried out by the following actions:

transmission 30 of a command for locking or unlocking to a communication unit 12a, 12b;

reception 31 of the command by the communication unit 12a, 12b and processing 32 the command to form a locking signal or an unlocking signal;

transmission 33 of the locking signal or of the unlocking signal to the locking device 11;

activation 34 of the locking device 11 to lock or unlock the energy store 10 in reaction to the locking signal or the unlocking signal.

In particular, the action of activating 34 the locking device 11 to lock can include a physical and/or electrical disconnection of a contact, internal to the energy store, of the at least one external contact 13 of the energy store 10.

The action of activating 34 the locking device 11 to unlock can moreover include a physical and/or electrical establishment of a contact, internal to the energy store, of the at least one external contact 13 of the energy store 10.

It is furthermore possible for the command (step 30) transmitted to the communication unit 12a, 12b to be an encrypted code for locking and/or unlocking. In particular, the processing 32 of the command can include a verification 32a and/or decoding 32b of the code.

The method can, only optionally, moreover include a transmission 35 of a confirmation signal of the communication unit 12a, 12b regarding the successful execution of the unlocking or locking of the energy store 10 to the external signal transmitter 14.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An electrical energy store for providing electrical drive energy for a motor vehicle, comprising:
at least one external electrical contact of the energy store; and
a locking device integrated in the electrical energy store, wherein
the locking device is configured for remotely controllable locking and/or unlocking of the at least one external electrical contact of the energy store.

2. The electrical energy store as claimed in claim 1, wherein
the locking device is configured for physical and/or electrical locking and/or unlocking of the at least one external electrical contact of the energy store.

3. The electrical energy store as claimed in claim 1, wherein
the locking device is configured for a communication exchange with a communication unit, in order to perform the locking in reaction to a lock signal transmitted from the communication unit to the locking device and/or to carry out the unlocking in reaction to an unlock signal transmitted from the communication unit to the locking device.

4. The electrical energy store as claimed in claim 3, wherein
the communication unit is integrated into the electrical energy store or is attached to the motor vehicle outside the energy store.

5. The electrical energy store as claimed in claim 3, wherein
the communication unit is configured for direct communication with an external signal transmitter in a form of a remote controller, a portable hand-held device, a mobile telephone, a smartphone, a portable computer or a tablet, in order to trigger the locking signal in reaction to a lock command from the signal transmitter, and/or to trigger the unlocking signal in reaction to an unlock command from the signal transmitter.

6. The electrical energy store as claimed in claim 4, wherein
the communication unit is configured for direct communication with an external signal transmitter in a form of a remote controller, a portable hand-held device, a mobile telephone, a smartphone, a portable computer or a tablet, in order to trigger the locking signal in reaction to a lock command from the signal transmitter, and/or to trigger the unlocking signal in reaction to an unlock command from the signal transmitter.

7. The electrical energy store as claimed in claim 3, wherein
the communication unit is configured for wireless communication with the external signal transmitter via infrared, NFC, WLAN, Bluetooth or by way of mobile radio communication.

8. The electrical energy store as claimed in claim 5, wherein
the communication unit is configured for wireless communication with the external signal transmitter via infrared, NFC, WLAN, Bluetooth or by way of mobile radio communication.

9. An electrically driven motor vehicle, comprising an electrical energy store as claimed in claim 1.

10. The electrically driven motor vehicle as claimed in claim 9, wherein the locking device is connected for communication exchange with a communication unit attached to the motor vehicle.

11. A method for remotely controllable locking or unlocking of an electrical energy store, wherein the energy store comprises at least one external electrical contact and a locking device integrated in the electrical energy store, the locking device being configured for remotely controllable locking and/or unlocking of the at least one external electrical contact of the energy store,
the method comprising the acts of:
receiving, by a communication unit, a transmitted command for locking or unlocking the electrical energy storage;
processing the transmitted command to form a locking signal or an unlocking signal;
transmitting the locking signal or the unlocking signal to the locking device; and
activating the locking device to lock or unlock the energy store in reaction to the locking signal or the unlocking signal.

12. The method as claimed in claim 11, wherein the act of activating the locking device to lock comprises a physical and/or electrical disconnection of a contact of the at least one external electrical contact of the energy store.

13. The method as claimed in claim 11, wherein the act of activating the locking device to unlock comprises a physical and/or electrical establishment of a contact of the at least one external electrical contact of the energy store.

14. The method as claimed in claim 12, wherein the act of activating the locking device to unlock comprises a physical and/or electrical establishment of a contact of the at least one external electrical contact of the energy store.

15. The method as claimed in claim 11, wherein the transmitted command to the communication unit comprises an encrypted code for locking and/or unlocking.

16. The method as claimed in claim 15, wherein the act of processing the transmitted command comprises a verification and/or decoding of the code.

17. The method as claimed in claim 11, wherein the transmitted command is received from an external signal transmitter in the form of a remote controller, a portable hand-held device, a mobile telephone, a smartphone, a portable computer or a tablet.

18. The method as claimed in claim 17, further comprising the act of:
transmitting a confirmation signal of the communication unit regarding successful execution of the unlocking or locking of the energy store to the external signal transmitter.

19. The method as claimed in claim 11, further comprising the act of:
transmitting a confirmation signal of the communication unit regarding successful execution of the unlocking or locking of the energy store to the external signal transmitter.
